(19) United States
(12) Patent Application Publication
(10) Pub. No.: US 2026/0092799 A1
(43) Pub. Date: Apr. 2, 2026

(54) BAROMETRIC LEVEL GAUGE, LIQUID STORAGE DEVICE, AND PLANT PROTECTION EQUIPMENT

(71) Applicant: GUANGZHOU XAIRCRAFT TECHNOLOGY CO., LTD., Guangzhou (CN)

(72) Inventors: Liming ZHANG, Guangzhou (CN); Weibo HUANG, Guangzhou (CN)

(73) Assignee: GUANGZHOU XAIRCRAFT TECHNOLOGY CO., LTD., Guangzhou (CN)

(21) Appl. No.: 19/388,927

(22) Filed: Nov. 13, 2025

Related U.S. Application Data
(63) Continuation of application No. PCT/CN2025/105736, filed on Jun. 30, 2025.

(30) Foreign Application Priority Data
Sep. 30, 2024 (CN) 202411378311.1
Sep. 30, 2024 (CN) 202422413692.4

(51) Int. Cl. G01F 23/18; A01M 7/00

(52) U.S. Cl. CPC G01F 23/185; A01M 7/0085

(57) ABSTRACT

A barometric level gauge includes: a housing, including a side wall, and a top cover plate and an inner partition plate respectively connected to the side wall, where a device mounting cavity is formed between the top cover plate and the inner partition plate and a vent chamber is formed on a side, back to the top cover plate, of the inner partition plate, the vent chamber is in communication with atmosphere, and the inner partition plate is provided with a first vent connecting the device mounting cavity to the vent chamber; and a pressure sensor, mounted in the device mounting cavity, where the pressure sensor includes a first sensitive element for sensing air pressure in the device mounting cavity. A problem of damage, caused by water, to the internal devices may be avoided.

### CROSS-REFERENCE TO RELATED APPLICATIONS

The present application is a continuation of International Application No. PCT/CN2025/105736, filed on June 30, 2025, which claims priority to Chinese Patent Application No. 202411378311.1, filed on September 30, 2024, and Chinese Patent Application No. 202422413692.4, filed on September 30, 2024. All of the aforementioned patent applications are hereby incorporated by reference in their entireties.

### TECHNICAL FIELD

The present disclosure relates to the technical field of sensing devices, and in particular, to a barometric level gauge, a liquid storage device, and a plant protection device.

### BACKGROUND

In the field of plant protection, pesticide automatic sprayer is usually integrated with a barometric level gauge. A main body of the barometric level gauge is generally installed on the top of a medicinal liquid tank with a vent tube extending to the bottom of the medicinal liquid tank, so that a height of the liquid in the medicinal liquid tank can be automatically monitored in real time using the barometric level gauge.

A pressure sensor disposed in the barometric level gauge is generally a differential pressure sensor to ensure enough detection accuracy. The differential pressure sensor has at least two pressure detection points, one of which is used to detect barometric pressure in the vent tube, and the other detection point is used to detect atmospheric pressure. By obtaining a difference between the internal and external pressures and converting it into a liquid level height, impact of atmospheric pressure changes on liquid level detection accuracy can be avoided.

Due to the need for a pressure sensor to be connected to the atmosphere in order to detect the atmospheric pressure, the pressure sensor cannot be installed in an absolutely sealed environment. Therefore, it is usually necessary to set up vents on a housing of the barometric level gauge to maintain atmospheric connection. However, in the field of agricultural plant protection, the working environment of equipment is usually outdoor, and rainwater, river water, and cleaning water that are usually in contact with it can easily invade the inside of the barometric level gauge through the vents, leading to damage, caused by water, to the pressure sensor and circuit board disposed inside the barometric level gauge in related technology.

Embodiments of the present disclosure aims to provide a barometric level gauge, a liquid storage device and a plant protection equipment, in order to solve a problem that pressure sensors and circuit boards are easy to be damaged by water in related technologies.

In order to achieve the above objective, the present disclosure adopts the following technical solutions.

In a first aspect, embodiments of the present disclosure provide a barometric level gauge, including: a housing, including a side wall, and a top cover plate and an inner partition plate respectively connected to the side wall, where a device mounting cavity is formed between the top cover plate and the inner partition plate and a vent chamber is formed on a side, back to the top cover plate, of the inner partition plate, the vent chamber is in communication with atmosphere, and the inner partition plate is provided with a first vent connecting the device mounting cavity to the vent chamber, enabling the device mounting cavity to communicate with the atmosphere; and a pressure sensor, mounted in the device mounting cavity, where the pressure sensor includes a first sensitive element for sensing air pressure in the device mounting cavity.

In a second aspect, a liquid storage device is provided. The liquid storage device includes a liquid storage tank and the barometric level gauge.

In a third aspect, a plant protection equipment is provided. The plant protection equipment includes a carrier, a spraying system and the liquid storage device. The spraying system and the liquid storage device are mounted on the carrier, and the spraying system is configured to pump and atomize medicinal liquid in the liquid storage device for spraying.

The beneficial effect of the present disclosure is that the present disclosure provides a barometric level gauge, a liquid storage device, and a plant protection equipment, where in the housing structure of the barometric level gauge, an inner partition plate is provided in the side wall separated from a top cover plate, so that a device installation cavity is formed between the top cover plate and the inner partition plate, and a vent chamber is formed underneath the inner partition plate, and at the same time a first vent is provided in the inner partition plate, so that the device installation cavity is able to communicate with the atmosphere through the vent chamber, realizing the device installation cavity and the device installation cavity, and realizing the device installation cavity. At the same time, the inner partition plate is provided with a first vent, so that the device mounting cavity can be connected to the atmosphere through the vent chamber, and the purpose of realizing that the pressure sensor in the device mounting cavity can sense the atmospheric air pressure is achieved. When this program is used, when there is a rain shower, cleaning water splash, etc., even if there is a small amount of water splash into the vent chamber,

the part of the water does not have enough kinetic energy to impact upward and through the first vents into the device mounting cavity, so this program can be installed in the device mounting cavity of the device (e.g., circuit boards, pressure sensors, etc.) to provide effective splash-proof water protection, to avoid damage to the internal devices in the presence of water.

### BRIEF DESCRIPTION OF THE DRAWINGS

The following is a further detailed description of the present disclosure based on accompanying drawings and embodiments.

FIG. 1 is a schematic structural diagram of an embodiment of a barometric level gauge according to an embodiment of the present disclosure.

FIG. 2 is a vertical sectional view of the barometric level gauge shown in FIG. 1.

FIG. 3 is an exploded schematic view of the barometric level gauge shown in FIG. 1 in a state of hiding an air guide tube.

FIG. 4 is a vertical sectional view of the barometric level gauge shown in FIG. 1 in a state of hiding an air guide tube.

FIG. 5 is an enlarged view of region A in FIG. 4.

FIG. 6 is an enlarged view of region B in FIG. 4.

FIG. 7 is a schematic structural diagram of a top side view of a housing base according to an embodiment of the present disclosure.

FIG. 8 is a schematic structural diagram of a bottom side view of a housing base according to an embodiment of the present disclosure.

FIG. 9 is a schematic structural diagram of a housing base in connection with a first waterproof tube according to an embodiment of the present disclosure.

FIG. 10 is a schematic structural diagram of a housing top cover according to an embodiment of the present disclosure.

FIG. 11 is a schematic structural diagram of an another embodiment of a barometric level gauge according to an embodiment of the present disclosure.

FIG. 12 is a vertical sectional view of the barometric level gauge shown in FIG. 11.

FIG. 13 is a vertical sectional view of yet another embodiment of a housing of a barometric level gauge according to an embodiment of the present disclosure.

### DETAILED DESCRIPTION OF THE EMBODIMENTS

In order to make the technical problems solved, technical solutions adopted and technical effects achieved by the present disclosure clearer, the technical solutions of the embodiments of

the present disclosure are described in further detail below, and it is obvious that the described embodiments are only a part of the embodiments of the present disclosure and not all of the embodiments. Based on the embodiments in the present disclosure, all other embodiments obtained by those skilled in the art without creative effort are within the protection scope of the present disclosure.

In the description of the present disclosure, unless otherwise expressly provided and limited, the terms "interconnected", "connected", "fixed" shall be broadly construed. For example, it may be a fixed connection, a detachable connection, or an integrated structure; it may be a mechanical connection or an electrical connection; it may be a direct connection or an indirect connection through an intermediate medium; it may be a connection within two elements or an interactive relationship between the two elements. For those skilled in the art, specific meaning of the above terms in the context of the present disclosure may be understood based on specific situations.

In the present disclosure, unless otherwise expressly provided and limited, a first feature "on" or "under" a second feature may include the first feature being in direct contact with the second feature, or the first feature being in contact with the second feature not directly but by means of another features. Furthermore, the first feature being "over”, “above" and "on" the second feature includes the first feature being directly above and diagonally above the second feature, or simply indicating that the first feature is horizontally higher than the second feature. The first feature being "below", "under", and "beneath" the second feature includes the first feature being directly below and diagonally below the second feature, or simply indicating that the first feature is horizontally lower than the second feature.

In the field of plant protection, a pesticide automatic sprayer is usually integrated with a barometric level gauge. A main body of the barometric level gauge is generally installed on the top of a medicinal liquid tank and integrated with a pressure sensor. A vent tube is provided to communicate with the pressure sensor. The vent tube extends to the bottom of the medicinal liquid tank, so that a height of the liquid in the medicinal liquid tank can be automatically monitored in real time using the barometric level gauge.

The pressure sensor disposed in a barometric level gauge in related technologies, which is located on the top of the medicinal liquid tank, is generally a differential pressure sensor to ensure enough detection accuracy. The differential pressure sensor has at least two pressure detection points, one of which is used to detect barometric pressure in the vent tube, and the other detection point is used to detect atmospheric pressure. By obtaining a difference between the internal and external pressures and converting it into a liquid level height, impact of atmospheric

pressure changes on liquid level detection accuracy can be avoided. Due to the need for the pressure sensor to be connected to the atmosphere in order to detect the atmospheric pressure, the pressure sensor cannot be installed in an absolutely sealed environment. Therefore, it is usually necessary to set up vents on a housing of the barometric level gauge to maintain atmospheric connection. However, in the field of agricultural plant protection, the working environment of equipment is usually outdoor, and rainwater, river water, and cleaning water that are usually in contact with it can easily invade the inside of the barometric level gauge through the vents, leading to damage, caused by water, to the pressure sensor and circuit board disposed inside the barometric level gauge in related technologies.

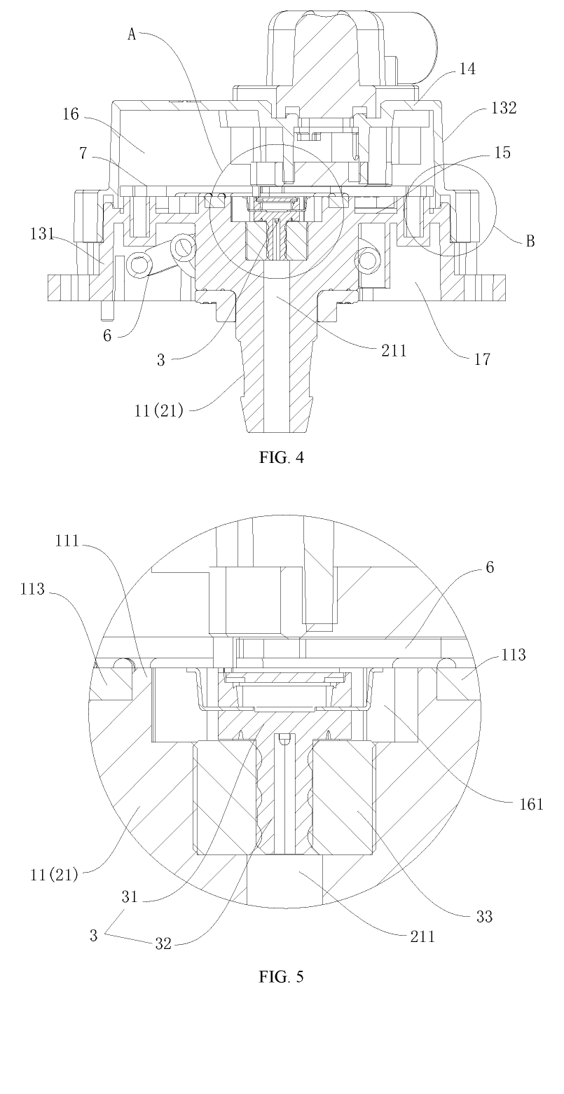

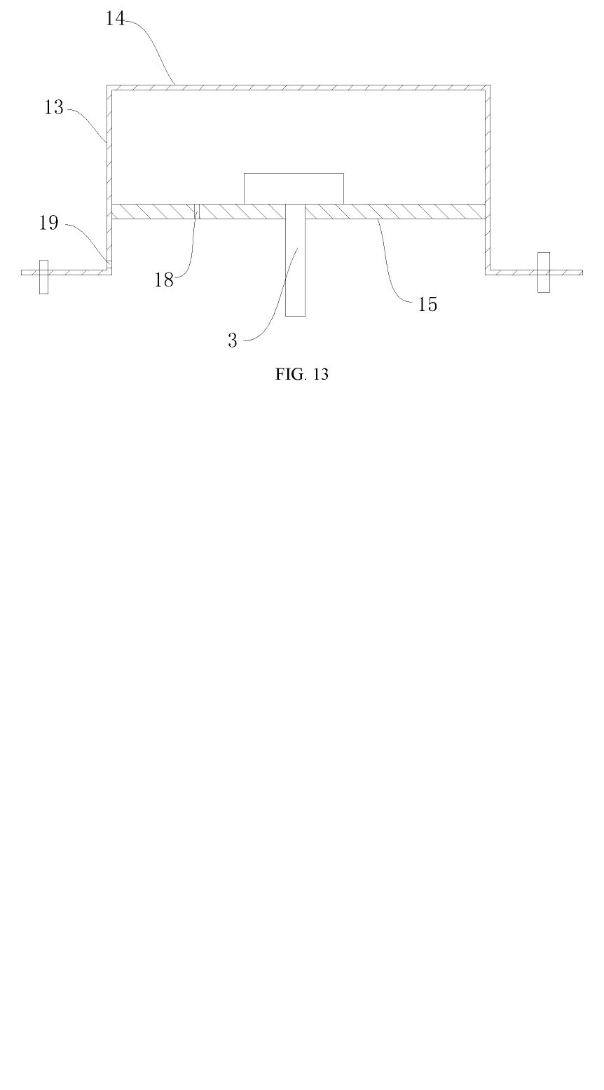

In order to overcome the above technical problems, referring to FIG. 4 or FIG. 13, the present embodiment provides another barometric level gauge, which is capable of effectively preventing splashing water from outside, such as rainwater, cleaning water, etc., from entering into the interior of the barometric level gauge, which may cause damage, caused by water, to the internal electronic devices.

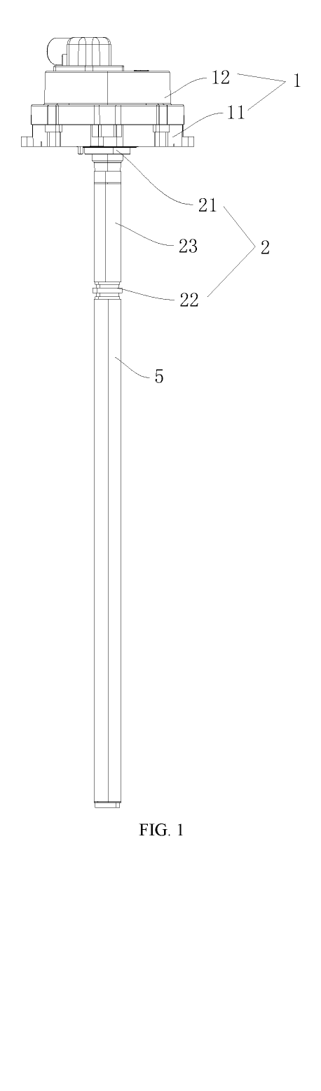

Referring to FIG. 1, FIG. 4 and FIG. 7, the barometric level gauge of the present embodiment includes a housing 1 and a pressure sensor. The housing 1 includes a side wall 13, and a top cover plate 14 and an inner partition plate 15 respectively connected to the side wall 13. A device mounting cavity 16 is formed between the top cover plate 14 and the inner partition plate 15, and a vent chamber 17 is formed on a side, back to the top cover plate 14, of the inner partition plate 15. The vent chamber 17 is in communication with the atmosphere, and the inner partition plate 15 is provided with first vent connecting the device mounting cavity 16 to the vent chamber 17, enabling the device mounting cavity 16 to communicate with the atmosphere. A pressure sensor is mounted in the device mounting cavity 16. The pressure sensor includes a first sensitive element for sensing air pressure in the device mounting cavity 16.

Specifically, the side wall 13, the top cover plate 14 and the inner partition plate 15 provided in the housing 1 are just able to enclose to form a separate device mounting cavity 16, and the pressure sensor, as well as a main control circuit board 7 and the like, can be mounted inside the device mounting cavity 16, and reliable protection is provided by the housing 1 to realize the functions of waterproofing, dustproofing and the like.

According to the present solution, a first vent 18 is provided in the inner partition plate 15 to connect the vent chamber 17 below the inner partition plate 15 to the atmosphere, so as to realize the purpose of communication between the device mounting cavity 16 and the atmosphere. Thus, the pressure sensor inside the device mounting cavity 16 can normally sense the atmospheric pressure.

The barometric level gauge of the present embodiment may be applied in various scenarios where a liquid level needs to be detected. Taking the barometric level gauge of the present embodiment applied to a medicinal liquid tank for plant protection as an example, during specific installation, the housing 1 is fixed at the top of the medicinal liquid tank, i.e., a bottom edge of the side wall 13 needs to be contacted with the medicinal liquid tank to be installed, and at this time, the side wall 13, the inner partition plate 15, and the medicinal liquid tank happen to enclose to form the aforementioned vent chamber 17. In order to connect the vent chamber 17 to the atmosphere, a hole may be provided in the side wall 13, or a hole or a slot, etc. may be provided in the medicinal liquid tank to connect with the vent chamber 17.

It can be understood that, after the application and installation of the barometric level gauge of the present embodiment, the inner partition plate 15 is located above the vent chamber 17, i.e., the first vent 18 provided in the inner partition plate 15 is also located above the vent chamber 17. When there is a scenario such as a rain shower or a cleaning, etc., even if splashed water enters into the vent chamber 17 through the side wall 13, or through the hole or the slot, etc., in the medicinal liquid tank 10 that are connected with the vent chamber 17, it is difficult to splash upwards again inside the vent chamber 17 and enter the device mounting cavity 16 through the first vent 18.

In view of above, based on the barometric level gauge of this embodiment, the inner partition plate 15 is provided in the side wall 13 and spaced apart from the top cover plate 14, so that the device mounting cavity 16 is formed between the top cover plate 14 and the inner partition plate 15, and the vent chamber 17 is formed under the inner partition plate 15. Meanwhile, the first vent 18 is provided in the inner partition plate 15, so that the device mounting cavity 16 is able to communicate with the atmosphere through the vent chamber 17, thereby enabling the pressure sensor in the device mounting cavity 16 to sense the atmosphere pressure. During the application of the present solution, when there is a rain shower, cleaning water splash, etc., even if there is a small amount of water splash into the vent chamber 17, the splashed water does not have enough kinetic energy to re-impact upward and through the first vent 18 into the device mounting cavity 16, so that devices installed in the device mounting cavity 16 (e.g., circuit boards, the pressure sensor, 3, etc.) may be provided with an effective splash-proof protection, to avoid damage, caused by water, to internal devices.

The barometric level gauge of the present embodiment can be applied in various scenarios in which liquid levels need to be detected, which may be, but are not limited to, industrial facilities such as reaction kettles and filtration tanks; household electrics such as washing machines and

dishwashers, and plant protection equipment such as agricultural medicinal liquid tanks and water tanks.

Advantages of the barometric level gauge of this embodiment applied in the scene of the medicinal liquid tank for agricultural plant protection are more obvious. Since the medicinal liquid tank for the plant protection operates in an outdoor environment, and it is difficult to avoid encountering a situation of rain, moreover, the user often needs to carry out cleaning operation of the barometric level gauge after usage, and the waterproof structure of the present embodiment can precisely cope with the demand of the scene where the medicinal liquid tank for plant protection often needs to cope with scenes of the various splashing water.

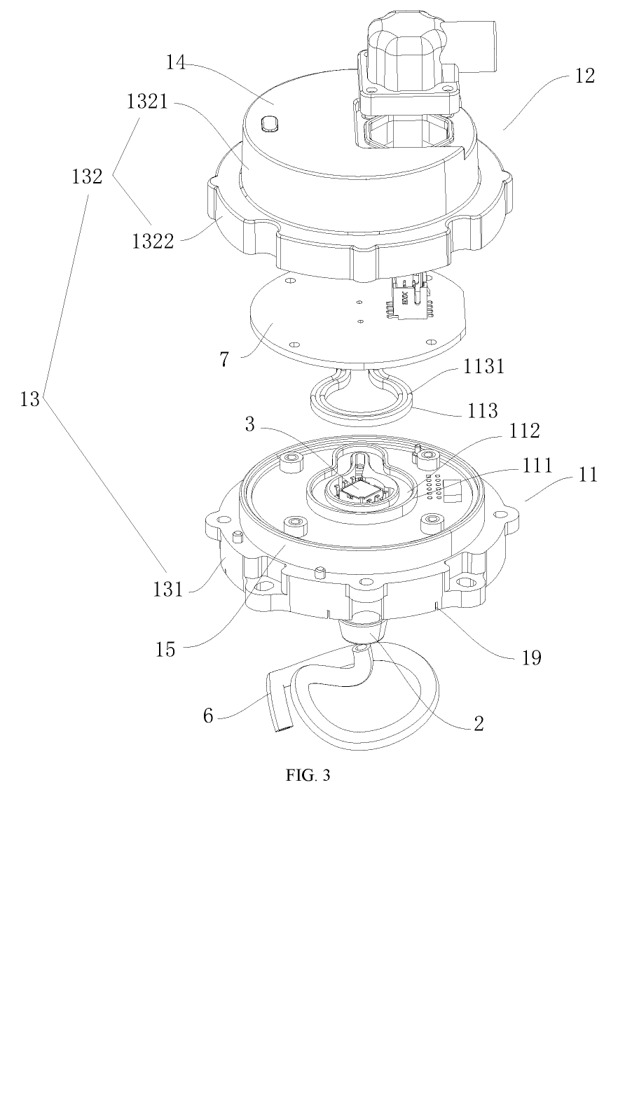

In an embodiment, referring to FIGS. 3, 4 and 9, a first waterproof tube 6 is provided in the vent chamber 17. One end of the first waterproof tube 6 is in communication with the first vent 18, and the other end is a free end, so that the device mounting cavity 16 communicates with the vent chamber 17 through the first waterproof tube 6.

Therein, under normal conditions, the first waterproof tube 6 is capable of connecting the device mounting cavity 16 with the vent chamber 17, enabling the device mounting cavity 16 to communicate with the atmosphere. When exposed to water, effective waterproofing can be realized by the first waterproof tube 6.

In an embodiment, the waterproof principle of the first waterproof tube 6 is similar to that of a capillary tube. When external liquid enters the first waterproof tube 6 through an end, away from the device mounting cavity 16, of the first waterproof tube 6, the liquid is easy to form a water column in the first waterproof tube 6 under liquid tension, and the water column can separate a space between the device mounting cavity 16 and the first waterproof tube 6 from the outside environment, acting as a seal to stop air between the pressure sensor 3 and the first waterproof tube 6 to be discharged. When the pressure of the external liquid is balanced with the pressure of the air inside the first waterproof tube 6, the liquid cannot continue to enter, thus achieving the purpose of waterproofing for the pressure sensor 3.

It should be noted that the first waterproof tube 6 provided in this embodiment is to provide fail-safe waterproof protection. In a course of conventional use, external splashed water cannot enter the first waterproof tube 6. During an immersion condition, based on the setting of the first waterproof tube 6, external water can be prevented from entering the device mounting cavity 16 through the first waterproof tube 6, thereby maintaining designed waterproof functionality even in the immersion condition. The advantage of the barometric level gauge with the first waterproof tube 6 is particularly obvious in application of an automatic spraying equipment carried by a drone. Since the barometric level gauge of the present solution can realize

effective waterproof function even if the entire barometric level gauge is soaked in water. In a case where the automatic spraying equipment is carried by the drone to carry out the work of plant protection, it is also possible to avoid water ingress into the interior of the barometric level gauge even if both the drone and pesticide tank become submerged when the drone meets accidental water ditching during overwater flight.

In addition, when the first waterproof tube 6 of the barometric level gauge is clogged with water, water in the first waterproof tube 6 can be expelled by shaking or tapping, etc., restore normal functionality of the barometric level gauge.

In the initial waterproof design of the pressure sensor 3, the most immediate thought of the inventor is to set up a waterproof breathable valve at a vent of the housing. The waterproof breathable valve provides gas-permeable yet water-impervious functionality, precisely meeting the dual performance requirements of ventilation and waterproofing. However, in practical application, the inventor found that when a permeable membrane inside the waterproof breathable valve sticks to water, it is necessary to disassemble the entire waterproof breathable valve, dry the permeable membrane and then reassemble it. The drainage process is complicated. More importantly, since the permeable membrane inside the waterproof breathable valve cannot be seen outside the waterproof breathable valve directly, the user is often unable to determine whether or not the permeable membrane sticks to water, and it is often necessary to disassemble the waterproof breathable valve and then check the permeable membrane, thus causing a certain burden on users' usage. After many experiments and research, the inventor creatively designed the breathable waterproof structure with the first waterproof tube 6 provided in embodiments of the present disclosure. A transparent tube may be adopted as the first waterproof tube 6, so that the user can intuitively observe whether the first waterproof tube 6 is waterlogged or not before usage. When the first waterproof tube 6 is found to be waterlogged, the water can be expelled by shaking or slight tapping the first waterproof tube 6. Compared to using a waterproof breathable valve for waterproofing, the first waterproof tube 6 of the present solution is more user-friendly.

In an embodiment, the first waterproof tube 6 includes a main body of the first waterproof tube 6 and a vent connector connected to each other, and the vent connector is connected with the first vent 18 through plug-in connection.

The first waterproof tube 6 can be split into two parts, the main body of the first waterproof tube 6 and the vent connector, realizing a modular design. This design allows for more flexible handling of different parts during production, installation and maintenance, improving overall work efficiency and convenience. The vent connector is connected to the first vent 18 through plug-in connection, which is not only simple and fast, but also ensures the sealing and

stability of the connection. Meanwhile, the plug-in connection also facilitates dismantling for maintenance and replacement when needed, reducing the maintenance cost.

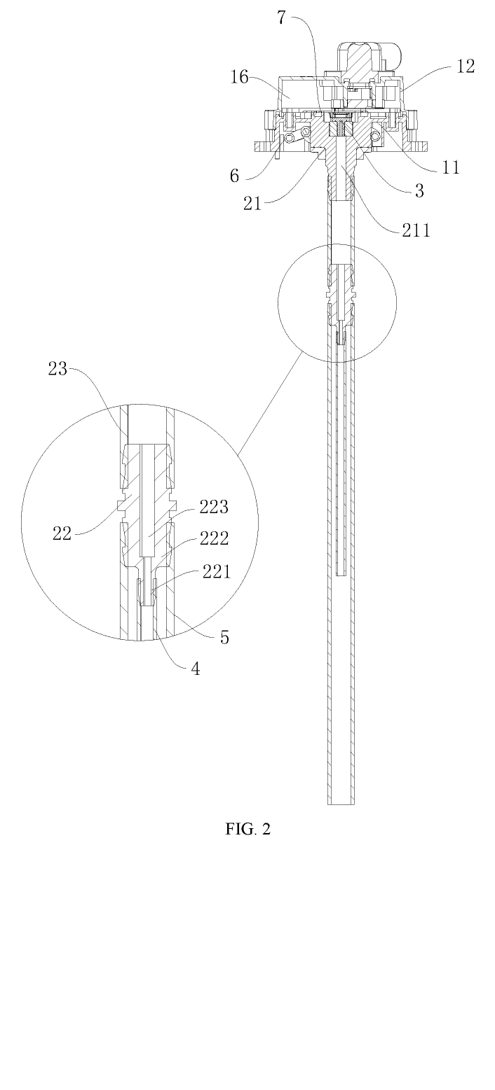

In an embodiment, as shown in FIG. 2, a flexible tube 23 is connected between the main body of the first waterproof tube 6 and the vent connector. An inner diameter of the flexible tube 23 is greater than an inner diameter of the main body of the first waterproof tube 6.

The setting of the flexible tube 23 makes maintenance of the first waterproof tube 6 more convenient. Specifically, when the first waterproof tube 6 is filled with water, due to the presence of the flexible pipe 23, users can directly squeeze out the water column inside the first waterproof tube 6 by using air pressure, so as to quickly restore the normal use function of the barometric level gauge. This design greatly simplifies the maintenance process and improves user's operation convenience.

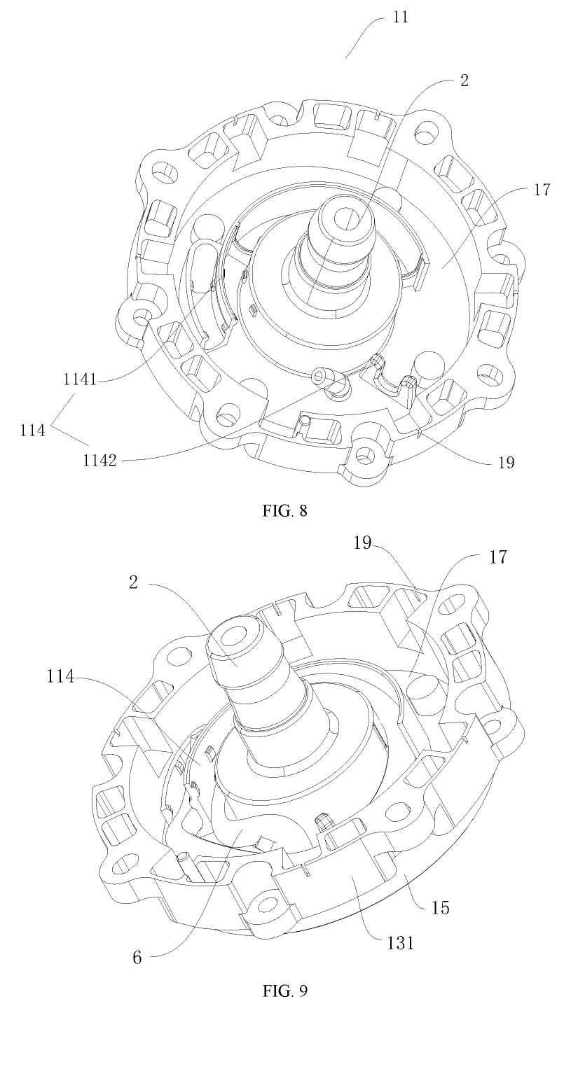

In an embodiment, referring to FIGS. 8 and 9, the inner partition plate 15 is provided with a tube clip 114 on the side, back to the top cover plate 14, of the inner partition plate 15 and the first waterproof tube 6 is fastened to the tube clip 114.

The design of the tube clip 114 enables the first waterproof tube 6 to be firmly fixed to the inner partition plate 15, avoiding loosening or falling off due to external factors such as vibration, impact, etc., and this solid connection ensures the reliability of the first waterproof tube 6 in the process of long-term use, and prevents a problem of leakage of water or air due to unstable connection.

In an embodiment, the inner partition plate 15 is provided with a connector 2 protruding backwardly to the top cover plate 14. The connector 2 is configured to be connected to an air guide tube 5, and the first waterproof tube 6 is coiled around the connector 2.

Specifically, a differential pressure sensor 3 is adopted as the pressure sensor 3, and the differential pressure sensor 3 includes at least a first sensitive element and a second sensitive element. The first sensitive element is configured to sense the atmospheric pressure and the second sensitive element is configured to sense the pressure of an air chamber connected to liquid. In order to realize that the first sensitive element and the second sensitive element can each perform its own function, in this embodiment, a connector 2 is provided on a side of the inner partition plate 15, and the connector 2 is connected to an air guide tube 5 extending into the liquid. A second sensing air chamber 211 is provided in the connector 2 in connection with the air guide tube 5. After the pressure sensor 3 is fixedly mounted inside the device mounting cavity 16, the first sensitive element is located exactly on the device mounting cavity 16 side, and the second sensitive element is located exactly facing the second sensing air chamber 211. After the pressure sensor 3 is installed, the second sensing air chamber 211 and the device mounting cavity 16 are precisely isolated, so

that as long as the device mounting cavity 16 is in communication with the atmosphere, the first sensitive element can sense the atmospheric pressure, and the second sensitive element can sense the air pressure on the liquid side. Referring to FIG. 5, in order to make the second sensing air chamber 211 and the device mounting cavity 16 be effectively isolated, the pressure sensor 3 includes a sensor body 31 and a sensor insertion tube 32. The first sensitive element is located on a side of the sensor body 31, and the second sensitive element is aligned with a tube lumen of the sensor insertion tube 32. At a connection position between the device mounting cavity 16 and the second sensing air chamber 211, a sealing ring 33 is provided. In the device mounting cavity 16, the sensor insertion tube 32 is inserted into the sealing ring 33, so that the second sensing air chamber 211 can be effectively isolated from the device mounting cavity 16 based on the installation of the pressure sensor 3 and the sealing ring 33.

When exposed to water, the external water may enter through the first waterproof tube 6 and a water column in the first waterproof tube 6 may be formed. The deeper the water is, the greater the external water pressure will be. With a greater pressure exerted by the water column to the device mounting cavity 16, the water column will be the longer, and gas in the device mounting cavity 16 will be compressed by the water column to a great degree, so that the air pressure in the device mounting cavity 16 increases to a larger extent. When a balance is achieved between the air pressure in the device mounting cavity 16 and the external water pressure, the water column cannot continue to extend inward. Therefore, a length of the water column that can be formed inside the first waterproof tube 6 determines the waterproofing ability of the device mounting cavity 16. The longer the length of the water column that can be formed, the device mounting cavity 16 can maintain effective waterproofing in the deeper the water, i.e., to obtain a better waterproofing capability and resistance to deep water. In this embodiment, the first waterproof tube 6 is set to form into a coiled shape around the connector 2, which can effectively utilize a limited space in the vent chamber 17 to fully arrange the first waterproof tube 6. Importantly, the coiled first waterproof tube 6 also has the advantage of a long length while occupying less space, which can obtain a better waterproofing capability and resistance to deep water.

In an embodiment, referring to FIG. 8, the tube clip 114 includes an arcuate tube clipping plate 1141. The arcuate tube clipping plate 1141 is provided on the side, back to the first vent 18, of the connector 2. A first tube clip groove is provided between the arcuate tube clipping plate 1141 and the connector 2 to clamp the first waterproof tube 6.

Since the first waterproof tube 6 is usually cylindrical or tubular in shape, the design of the arcuate tube clipping plate 1141 can better adapt to the shape of the first waterproof tube 6, and the arcuate tube clipping plate 1141 can be tightly adapted to the first waterproof tube 6 to

provide an even clamping force and reduce a problem of obstruction of ventilation caused by twists and turns in the middle of the first waterproof Tube 6. Moreover, the arcuate tube clipping plate 1141 can combine with an outer wall of the connector 2 to fix the first waterproof tube 6, realizing a purpose of simplifying the structure of the tube clip 114.

In an embodiment, the tube clip 114 includes a block 1142 disposed close to the first vent 18, and the block 1142 is provided with a second tube clip groove to clamp the first waterproof tube 6.

Specifically, the first waterproof tube 6 needs to be disposed avoiding the position closer to the first vent 18, so the block 1142 which occupies less space is provided for fixation, i.e., it meets the need of fixing the first waterproof tube 6 while avoiding squeezing of the waterproof tube itself.

In an embodiment, the first waterproof tube 6 utilizes the principle of surface tension of water to form a water column in the first waterproof tube 6 when water is entering to prevent further intrusion of external water into the pressure sensor 3 through the first waterproof tube 6.

Specifically, to realize the waterproof function of the first waterproof tube 6 by utilizing the principle of surface tension of liquid, it is only necessary to set the inner diameter of the first waterproof tube 6 small enough to form a water column therein when water enters, and the first waterproof tube 6 of this structure has the advantages of simple structure and low cost.

In an embodiment, the inner diameter of the first waterproof tube 6 ranges from 1.5 mm to 3.5 mm.

By setting the inner diameter of the first waterproof tube 6 to range from 1.5 mm to 3.5 mm, normal air permeability requirements may be satisfied while realizing the function of waterproofing by using liquid surface tension to form a water column inside the first waterproof tube 6.

Further preferably, the inner diameter of the first waterproof tube 6 may range from 2.5 mm to 2.7mm, which is sufficient for stable air permeability and can ensure stable formation of a water column when water enters.

In an embodiment, referring to FIGS. 7 to 8, the side wall 13 is provided with a second vent 19 connected to the vent chamber 17, enabling the vent chamber 17 to communicate with the atmosphere.

By providing the second vent 19 in the side wall 13 to realize air permeability, there is no need to set corresponding holes or slots in the medicinal liquid tank which is installed in, so that the barometric level gauge of the present embodiment can be directly applied to the medicinal

liquid tank in related technologies, and be used normally without any improvement to the medicinal liquid tank.

Regarding the setup form of the housing 1, in an embodiment, referring to FIGS. 3, 4 and 6, the housing 1 includes a housing base 11 and a housing top cover 12. The housing base 11 includes a first enclosure plate 131 and the inner partition plate 15 connected to each other. The housing top cover 12 includes a second enclosure plate 132 and the top cover plate 14 connected to each other. The housing top cover 12 is mounted onto the housing base 11. The first enclosure plate 131 is connected with the second enclosure plate 132 and the top cover plate 14, and the first enclosure plate 131 is connected with the second housing 132 to form the side wall 13. The second vent 19 is provided in the first housing 131.

The housing 1 can be divided into two modules, the housing base 11 and the housing top cover 12. Such design enables that each part can be individually manufactured and processed, and then assembled, and this modular design not only improves the production efficiency, but also facilitates subsequent maintenance and replacement. The housing top cover12 is mounted onto the housing base 11 through appropriate fixing methods (such as snap, screw, etc.), to ensure a tight connection between the two a tight connection between the two. This assembly method is not only simple and fast, but also ensures the sealing and stability of the housing 1.

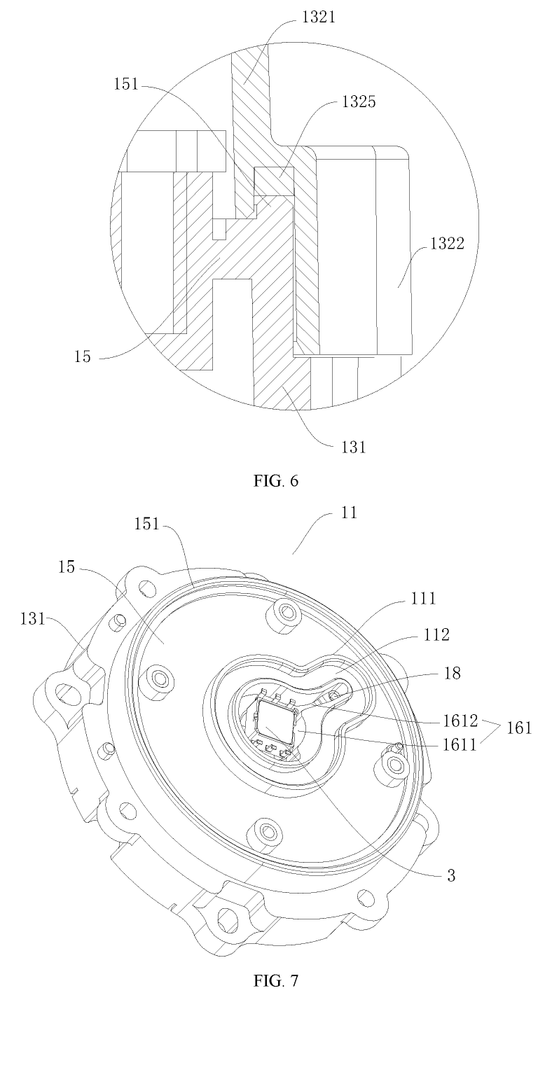

In an embodiment, referring to FIGS. 6 and 7, the inner partition plate 15 is provided protruding, relative to the first enclosure plate 131, towards the top cover plate 14, and the inner cavity of the second enclosure plate 132 corresponds to an external dimension of the inner partition plate 15. The inner partition plate 15 is embedded in the second enclosure plate 132.

Since the inner partition plate 15 is embedded within the second enclosure plate 132, when the housing top cover 12 is mounted onto the housing base 11, the second enclosure plate 132 will automatically be aligned with and in close contact with the first enclosure plate 131. This design simplifies the assembling process, reduces the requirement of assembling precision, and improves the production efficiency. The inner partition plate 15 protrudes, relative to the first enclosure plate 131, towards the side where the top cover plate 14 is located and is embedded in the second wall plate 132, so that the inner partition plate 15 can be used as a locating and fixing point between the housing top cover 12 and the housing base 11 during the assembling process, which strengthens overall structural stability of the housing 1. Through the close fit between the inner partition plate 15 and the second enclosure plate 132, and the contact between the inner partition plate 15 and the first enclosure plate 131, a continuous sealing barrier is formed between the vent chamber 17 and the device mounting cavity 16 in the housing 1. This sealing barrier

effectively prevents the penetration of medicinal fluids or other impurities into internal components, ensuring the normal operation and long-term stability of the barometric level gauge.

In an embodiment, referring to FIG. 6, the second enclosure plate 132 includes a first enclosure portion 1321 and a second enclosure portion 1322 connected in a stepped structure. A step portion 1323 in parallel with the inner partition plate 15 is formed between the first enclosure portion 1321 and the second enclosure portion 1322. A waterproofing ring 1325 is provided in the first enclosure portion 1321 to abut against the step portion 1323, and the inner partition plate 15 is embedded in the first enclosure portion 1321 and against the waterproofing ring 1325.

The inside of first enclosure portion 1321 is fitted with the waterproof ring 1325, which is tightly fitted against the step portion 1323. The waterproof ring 1325 is usually made of soft and elastic material, such as rubber or silicone, in order to ensure a good sealing effect. The inner partition plate 15 is embedded into the first enclosure portion 1321 and directly pressed against the waterproof ring 1325. This design enables the inner partition plate 15 not only to be firmly supported, but also to form a tight sealing connection between the waterproof ring 1325 and the housing 1, which effectively prevents the leakage of liquids or gases from gaps of the housing 1.

In an embodiment, the step portion 1323 is provided with an annular groove 1324, and the waterproof ring 1325 is embedded in the annular groove 1324.

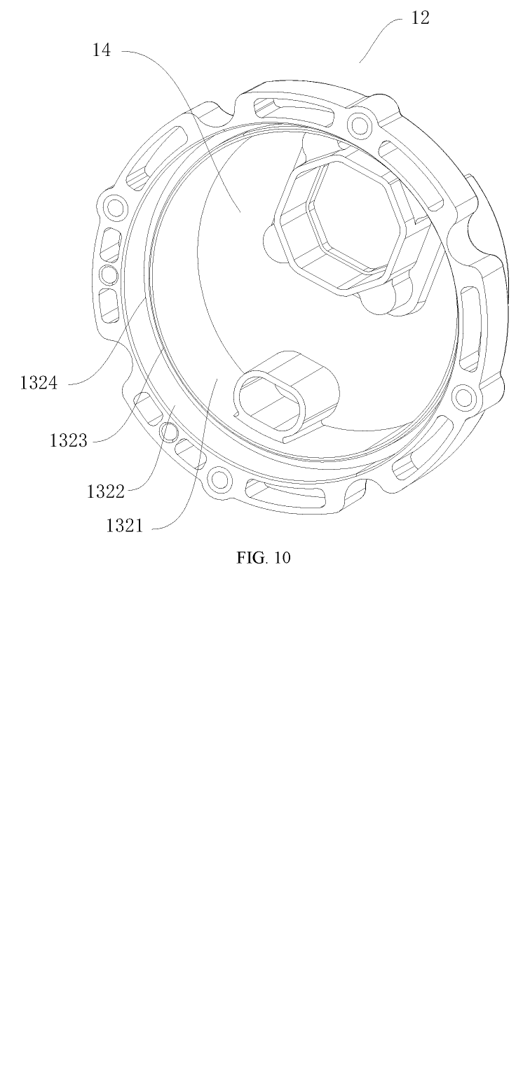

Referring to FIG. 10, the step portion 1323 is provided with the annular groove 1324, which is designed for the installation of the waterproof ring 1325, and the shape and size of the annular groove 1324 matches that of the waterproof ring 1325, ensuring that the waterproof ring 1325 can be securely embedded therein. The waterproof ring 1325 is embedded in the annular groove 1324, and this mounting method not only simplifies the assembly process, but also makes a tight fit between the waterproof ring 1325 and the step portion 1323, thereby improving the sealing effect.

In an embodiment, the inner partition plate 15 is provided with an annular flange 151 at a peripheral of the inner partition plate 15, and the annular flange 151 is embedded in the annular groove 1324 to be abut against the waterproof ring 1325. This embedded design makes a continuous and tight sealing structure between the inner partition plate 15, the waterproofing ring 1325, and the step portion 1323, which further improves the sealing effect of the waterproofing ring 1325, and ensures the dryness and cleanliness of the interior of the housing 1.

Regarding the setting form of the housing 1, in another embodiment, referring to FIG. 13, the side wall 13 and the top cover plate 14 are of an integrated structure, and the inner partition plate 15 is embedded in the side wall 13.

This structure can also realize the structure of forming a device mounting cavity 16 and a vent chamber 17 respectively above and below the inner partition plate 15 to realize the waterproof purpose.

In an embodiment, a mounting tab is provided on a side, away from the top cover plate 14, of the sidewall 13, and the mounting tab is provided with a mounting hole.

The side wall 13 is provided with the mounting tab at the periphery, and the mounting tab is provided with the mounting hole, which facilitates the installation of the barometric level gauge of the present embodiment to the medicinal liquid tank. Specifically, when mounted, the medicinal liquid tank is provided with threaded holes, and reliable fixation of the barometric level gauge can be realized by locking a screw bolt attached to the threaded holes after passing it through the mounting hole.

On the other hand, embodiments of the present disclosure provides a liquid storage device, including a liquid storage tank and a barometric level gauge as described above. The housing 1 of the barometric level gauge is mounted on the top of the liquid storage tank, and an end, away from the housing 1, of an air guide tube 5 of the barometric level gauge extends inside the liquid storage tank.

Similarly, the barometric level gauge in the liquid storage device of the present embodiment has the advantage of good waterproof capability.

On another hand, embodiments of the present disclosure provides a plant protection equipment, including a carrier, a spraying system, and the aforementioned liquid storage device. The spraying system and the liquid storage device are mounted on the carrier, and the spraying system is configured to pump and atomize medicinal liquid in the liquid storage device for spraying.

Therein, the carrier may be an unmanned vehicle, an unmanned aircraft, an artificially driven vehicle and the like.

The spraying system includes a pumping device and an atomizer, etc. Pipelines at both ends of the pumping device are connected to the storage tank and the atomizer respectively, and the medicinal liquid in the storage tank is pumped out by the pumping device and then uniformly sprayed on the crop after atomization by the atomizer. Based on the transportation of the carrier, mobile spraying operation can be realized.

Based on the liquid storage device of the present embodiment, similarly, the barometric level gauge in the plant protection equipment of the present embodiment has the advantages of strong waterproof capability and long service life.

Under normal circumstances, since the barometric level gauge is located at the top of the medicinal liquid tank, the medicinal liquid inside the medicinal liquid tank cannot contact the

barometric level gauge by backflow through a vent tube. Since it is impossible to seal the pressure sensor 3 from the vent tube in order to satisfy the normal demand for venting, the existing pressure sensor 3 is generally connected to the vent tube to be exposed to the air. This leads to a problem that, in an event of an accidental tipping or even inversion of the medicinal liquid tank, the medicinal liquid is prone to flow backward through the vent tube and come into contact with the pressure sensor 3, thereby causing the problem of water ingress and damage to the pressure sensor 3 at a side connected to the vent tube.

In order to overcome the above technical problems, the present embodiment also provides another type of barometric level gauge that can meet the need of the pressure sensor 3 to sense the gas pressure on the liquid side while at the same time provide reliable waterproofing in case of an emergency, so as to provide reliable protection for the pressure sensor 3. It should be noted that the barometric level gauge of this embodiment can be applied in combination with design points of the barometric level gauge of any one or more of the above embodiments.

Referring to FIG. 2, the barometric level gauge of the present embodiment includes at least a pressure sensor 3, a second waterproof tube 4, and an air guide tube 5. The second waterproof tube 4 is connected to the pressure sensor 3. An inner diameter of the air guide tube 5 is greater than an inner diameter of the second waterproof tube 4. One end of the air guide tube 5 is connected to the pressure sensor 3 through the second waterproof tube 4, and the other end is configured to extended into a liquid to sense water pressure.

The barometric level gauge of the present embodiment utilizes the principle of air pressure detection to realize a function of detecting a height of the liquid level. In specific application, an end, away from the second waterproof tube 4, of the air guide tube 5 extends into the liquid, so that a closed cavity is formed by enclosure of the pressure sensor 3, the second waterproof tube 4, the air guide tube 5, and the liquid. The liquid exerts pressure on the air in that cavity, the pressure sensor 3 is configured to detect air pressure of the air. The higher the liquid level of the liquid is, the more the air pressure is detected by the barometric sensor 3. The higher the liquid level, the higher the pressure exerted by the liquid to the air in the cavity, and the higher the air pressure value detected by the pressure sensor 3, i.e., the liquid level height can be converted by the air pressure value detected by the pressure sensor 3.

Therein, the waterproof principle of the second waterproof tube 4 is similar to that of a capillary tube. When external liquid enters the second waterproof tube 4 through an end, away from the pressure sensor 3, of the second waterproof tube 4, the liquid is easy to form a water column in the second waterproof tube 4 under liquid tension, and the water column can separate a space between the pressure sensor 3 and the second waterproof tube 4 from the outside

environment, acting as a seal to stop air between the pressure sensor 3 and the second waterproof tube 4 to be discharged. When the pressure of the external liquid is balanced with the pressure of the air inside the second waterproof tube 4, the liquid cannot continue to enter, thus achieving the purpose of waterproofing for the pressure sensor 3.

It should be noted that the second waterproof tube 4 set up in the present disclosure, in a course of conventional use, the end connected to the air guide tube 5 does not extend into the liquid. Since the waterproofing principle of the second waterproof tube 4 is to use the liquid's own tension to realize. When the liquid enters into the second waterproof tube 4, it is easy to form a water column inside the second waterproof tube 4. It is difficult for the water column to fade away freely under the action of its own gravity, and the height of the water column is not easy to change. This leads to a problem that the air pressure inside the second waterproof tube 4 cannot accurately respond to the pressure exerted by the liquid thereon, i.e., the air pressure value sensed by the pressure sensor 3 cannot sensitively respond to the height of the liquid level, which directly leads to the failure of the barometric level gauge. Therefore, in the present disclosure, an air guide tube 5 is provided and plays a vital role as an intermediate bridge connecting the second waterproof tube 4 and the liquid. An inner diameter of the air guide tube 5 is relatively large, and it is not easy to form a water column in the air guide tube 5 under the liquid's own tension. The height of the liquid level in the air guide tube 5 will also sensitively follow the changes when the liquid level is changing. Therefore, the air pressure inside the air guide tube 5 can accurately respond to the liquid pressure. The second waterproof tube 4 is connected to the air guide tube 5, therefore, the second waterproof tube 4 cannot accurately respond to the liquid pressure. In view of above, in the present embodiment, not only the second waterproof tube 4 is provided for the air permeability and waterproof basis of the pressure sensor 3, but also the air guide tube 5 is provided to extend into the liquid, so that the second waterproof tube 4 will never come into contact with water under normal use, which can avoid the problem of the second waterproof tube 4 affecting the accuracy of the liquid level detection after the water enters.

In specific application, according to demand of usage, the pressure sensor used in the barometric level gauge may be an absolute pressure sensor, or a differential pressure sensor. When the absolute pressure sensor is used, only one sensitive element is provided thereon, and the sensitive element can sense the air pressure in the second waterproof tube 4. When the differential pressure sensor is adopted, two sensitive elements are provided in the differential pressure sensor, one of which is configured to sense the air pressure inside the second waterproof tube 4, and the other sensitive element is configured to sense the atmospheric pressure, so that a difference in the air pressure detected by the two sensitive elements can accurately reflect an actual height of the

liquid level, and to avoid impact on the detection of the liquid level when the atmospheric pressure changes.

In view of above, based on the barometric level gauge of the present embodiment, the barometric level gauge is provided with the second waterproof tube 4 for connecting the air guide tube 5 to the pressure sensor 3. Under normal conditions, the second waterproof tube 4 can connect the air guide tube 5 with the pressure sensor 3, so that the pressure sensor 3 can normally sense the air pressure in the air guide tube 5, and realize the function of liquid level detection. The waterproof principle of the second waterproof tube 4 is similar to that of the capillary tube. When external liquid enters the pressure sensor 3 through an end, away from the pressure sensor 3, of the second waterproof tube 4, the liquid is easy to form a water column in the second waterproof tube 4 under the liquid tension. The water column can separate a space between the pressure sensor 3 and the second waterproof tube 4 from the outside environment, acting as a seal to stop air between the pressure sensor 3 and the second waterproof tube 4 to be discharged. When the pressure of the external liquid is balanced with the pressure of the air inside the second waterproof tube 4, the liquid cannot continue to enter, thus achieving the purpose of waterproofing for the pressure sensor 3.

The barometric level gauge of the present embodiment can be applied in various scenarios in which liquid levels need to be detected, which may be, but are not limited to, industrial facilities such as reaction kettles and filtration tanks; household electrics such as washing machines and dishwashers, and plant protection equipment such as agricultural medicinal liquid tanks and water tanks.

Advantages of the barometric level gauge of this embodiment applied in the scene of the medicinal liquid tank for agricultural plant protection are more obvious. Since the medicinal liquid tank needs to be continuously transferred for operation in an agricultural field, it is generally carried on an unmanned vehicle, a drone, or an artificially piloted vehicle, or it is directly moved on the back of an artificial person, i.e., the medicinal liquid tank is a structure that is easy to be moved and transferred. During use, it is easy for the medicine tank to tip over, which can cause the medicinal liquid to flow back and contaminate the pressure sensor 3. Moreover, the medicinal liquid itself has a certain degree of corrosiveness, which makes it more likely to cause damage to the pressure sensor 3. The design of the second waterproof tube 4 of the present solution is precisely able to effectively avoid the problem of water ingress into the pressure sensor 3 caused by the medicinal liquid tank when it is tipped over, so the advantages of the barometric level gauge of the present solution applied in the scenario of the medicinal liquid tank for agricultural plant protection are more obvious.

In the initial waterproof design of the pressure sensor 3, the most immediate thought of the inventor is to set up a waterproof breathable valve at a vent of the housing. The waterproof breathable valve provides gas-permeable yet water-impervious functionality, precisely meeting the dual performance requirements of ventilation and waterproofing. However, in practical application, the inventor found that when a permeable membrane inside the waterproof breathable valve sticks to water, it is necessary to disassemble the entire waterproof breathable valve, dry the permeable membrane and then reassemble it. The drainage process is complicated. More importantly, since the permeable membrane inside the waterproof breathable valve cannot be seen outside the waterproof breathable valve directly, the user is often unable to determine whether or not the permeable membrane sticks to water, and it is often necessary to disassemble the waterproof breathable valve and then check the permeable membrane, thus causing a certain burden on users' usage. After many experiments and research, the inventor creatively designed the breathable waterproof structure with the second waterproof tube 4 in embodiments of the present disclosure. A transparent tube may be adopted as the second waterproof tube 4, so that the user can intuitively observe whether the second waterproof tube 4 is waterlogged or not before usage. When the second waterproof tube 4 is found to be waterlogged, the water can be expelled by shaking or slight tapping the second waterproof tube 4. Compared to using a waterproof breathable valve for waterproofing, the second waterproof tube 4 of the present solution is more user-friendly.

In an embodiment, referring to FIGS. 2 and 4, the pressure sensor 3 further includes a connector 2. The connector 2 is provided with a second sensing air chamber 211. The pressure sensor 3 includes a second sensitive element for sensing the air pressure inside the second sensing air chamber 211, and the second waterproof tube 4 is connected to the connector 2 and communicate with the second sensing air chamber 211.

Specifically, the connector 2 is set to provide mounting support for the pressure sensor 3 and to realize the function of indirect connection between the pressure sensor 3 and the second waterproof tube 4. Importantly, a closed second sensing air chamber 211 may be provided within the connector 2, which is isolated from the external environment and is connected to the second waterproof tube 4 and the air guide tube. The air pressure within the second pressure sensor 3 may accurately respond to the pressure exerted by the liquid, realizing the function of accurately detection of the liquid level. In conclusion, the setting of the connector 2 provides a reliable bridge for the connection between the pressure sensor 3 and the second waterproof tube 4, effectively ensuring the airtightness of the connection structure.

In specific implementation, the pressure sensor 3 may be completely or partially mounted into the second sensing air chamber 211. The pressure sensor 3 may also be mounted on the outer

surface of the connector 2 (i.e., the pressure sensor 3 does not extend into the second sensing air chamber 211), as long as the second sensitive element thereon is able to be aligned towards the second sensing air chamber 211.

In another embodiment, the pressure sensor 3 includes a sensor body 31 and a sensor insertion tube 32. The second sensitive element is aligned with a tube lumen of the sensor insertion tube 32. The end of the second waterproof tube 4 is directly socketed to the sensor insertion tube 32, which enables the second sensitive element to accurately sense the air pressure within the second waterproof tube 4.

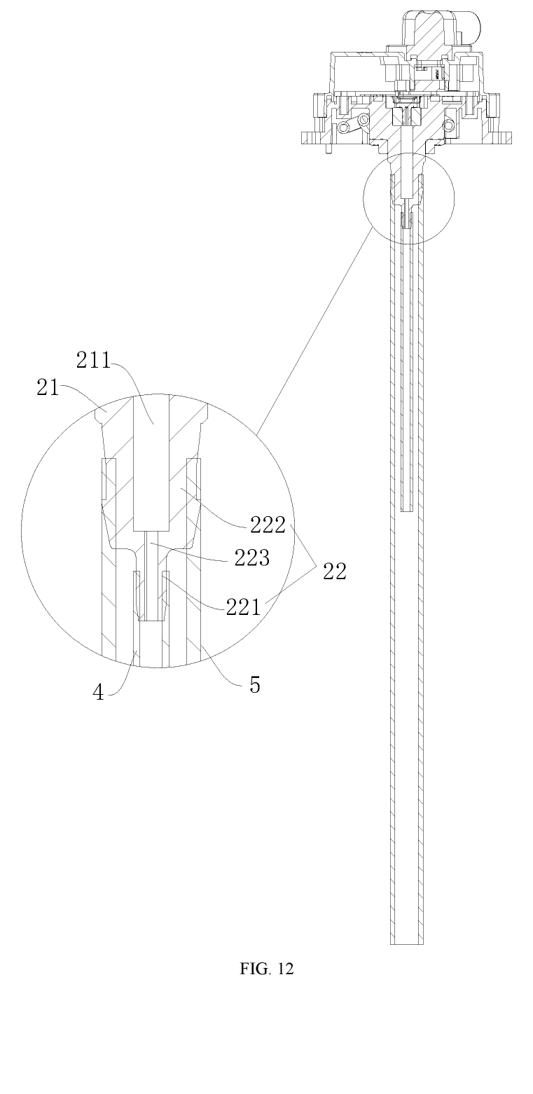

Regarding the connection between the second waterproof tube 4 and the air guide tube 5, in one embodiment, referring to FIG. 2 or FIG. 12, the connector 2 includes a connecting head 22. The connecting head 22 includes a second connecting post 222 and a first connecting post 221 connected to each other. The connecting head 22 is provided with a ventilation channel 223 through the second connecting post 222 and the first connecting post 221. The ventilation channel 223 is connected to the second sensing air chamber 211. The second waterproof tube 4 is connected to the first connecting post 221, and the air guide tube 5 is provided outside the second waterproof tube 4 and connected to the second connecting post 222.

In this embodiment, the second connecting post 222 and the first connecting post 221 are provided in the connecting head 22, both of which are connected the air guide tube 5 and the second waterproof tube 4 respectively. Therefore, the diameter of the second connecting post 222 needs to be set up correspondingly with the air guide tube 5, and the diameter of the first connecting post 221 needs to be set up correspondingly with the second waterproof tube 4. The key to this structure is to realize a socketing structure of the air guide tube 5 and the second waterproof tube 4, i.e., the second waterproof tube 4 is extended into the air guide tube 5. When the barometric level gauge is inverted, the liquid will first fill the space between the second waterproof tube 4 and the air guide tube 5, and only when the height of the liquid exceeds the height of the free end of the second waterproof tube 4, the liquid will be able to enter into the second waterproof tube 4. This is an extremely obvious advantage in the application of the medicinal liquid tank for plant protection. Specifically, the medicinal liquid tank usually cannot be completely emptied after use, and a small amount of liquid will remain in the medicinal liquid tank. Meanwhile, the medicinal liquid tank is lightweight after use, and is prone to be dumped or inverted. When dumped or inverted, a small amount of liquid is prone to enter through the free end of the air guide tube 5. After entering, the small amount of liquid will remain in the space between the second waterproof tube 4 and the air guide tube 5, and the liquid will enter into the space between the second waterproof tube 4 and the air guide tube 5. After entering, the small amount of medicinal liquid

will be stored in the space between the second waterproof tube 4 and the air guide tube 5, so as to avoid the problem of water entering into the second waterproof tube 4. If water cannot enter into the second waterproof tube 4, the user does not need to dissemble it for draining when using it in a later stage, and thus it is convenient for the user to use it.

In an embodiment, the second waterproof tube 4 is socketed to the first connecting post 221; and/or, the air guide tube 5 is socketed to the second connecting post 222.

The use of the socketed connection structure further enhances the sealing and solidity of the connection between the tube and the connector 2.

Preferably, both the second connecting post 222 and the first connecting post 221 are set as a pagoda connecting head 22 to enhance the reliability of the connection.

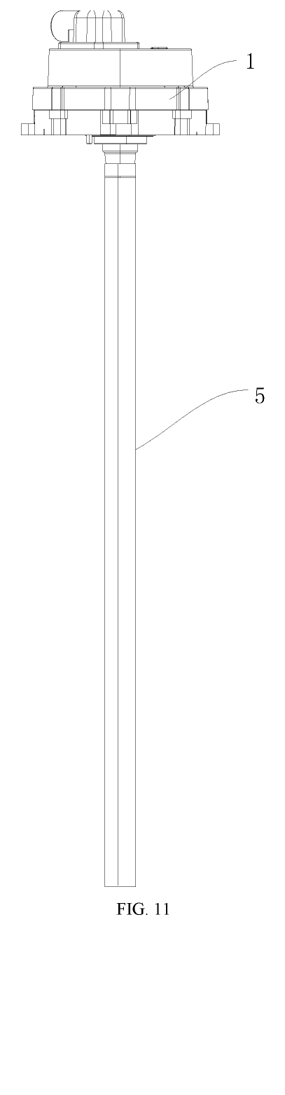

Regarding the form of setting of the connector 2, in an embodiment, referring to FIGS. 11 to 12, the connector 2 includes a mounting seat 21 and the connecting head 22. The second sensing air chamber 211 is provided in the mounting seat 21, and the connecting head 22 and the mounting seat 21 are of an integrated structure.

The mounting seat 21 can be specifically used for mounting of the pressure sensor 3, making the installation of the pressure sensor 3 stable. The second sensing air chamber 211 is provided in the mounting seat 21, so that the second sensitive element in the pressure sensor 3 can be aligned towards the second sensing air chamber 211 once the pressure sensor 3 is installed.

When implemented, the mounting seat 21 may also be provided to be capable of mounting a pneumatic device (e.g., a main control circuit board 7, etc.). In addition, the mounting seat 21 may also be designed to be a structure that can be connected to the medicinal liquid tank, so that the barometric level gauge of this embodiment can be reliably installed on the medicinal liquid tank.

By designing the mounting seat 21 and the connecting head 22 as an integrated structure, the overall structural strength of the connector 2 is significantly improved, and this design is capable of resisting greater external forces and vibrations, ensuring the stability and reliability of the connector 2 under severe working conditions. The design of the integrated structure simplifies the manufacturing process of the connector 2. In the manufacturing process, the processing and assembly of the mounting seat 21 and the connecting head 22 can be completed in one go, which reduces the production cost and improves the production efficiency. Since there is no additional connection gap between the mounting seat 21 and the connecting head 22, the risk of leakage due to poor connection is reduced, and this design helps to ensure the airtightness of the interior of the connector 2 and the accuracy of air pressure transmission.

Regarding the form of setting of the connector 2, in another embodiment, referring to FIGS. 1 to 2, the connector 2 includes a mounting seat 21, a flexible tube 23, and the connecting head 22. The second sensing air chamber 211 is provided in the mounting seat 21, and both ends of the flexible tube 23 are connected to the mounting seat 21 and to the connecting head 22 respectively, so as to connect the second sensing air chamber 211 to the ventilation channel 223.

The connector 2 adopts an innovative design including the mounting seat 21, the flexible tube 23 and the connecting head 22, where the flexible tube 23 serves as a key component connecting the mounting seat 21 to the connecting head 22, not only realizing the conduction between the second sensing air chamber 211 and the ventilation channel 223, but also endowing the connector 2 with a unique ease of maintenance.

The mounting seat 21 can be specifically used for mounting the pressure sensor 3, enabling the pressure sensor 3 to be mounted stably. The second sensing air chamber 211 is provided in the mounting seat 21, and the second sensitive element on the pressure sensor 3 can be aligned towards the second sensing air chamber 211 after the pressure sensor 3 is mounted. Both ends of the flexible tube 23 are connected to the mounting seat 21 and the connecting head 22 respectively, which ensures smooth conduction between the second sensing air chamber 211 and the ventilation channel 223, and enables the air pressure to be unobstructedly passed from the air guide tube 5 through the connecting head 22 and the flexible tube 23 to the second sensing air chamber 211 finally, so that the air pressure is accurately sensed by the pressure sensor 3. When the second waterproof tube 4 is filled with water, a conventional connector may need to be disassembled to multiple parts for draining, whereas in this embodiment, due to the presence of the flexible tube 23, the user can directly squeeze the flexible tube 23 to squeeze out the water column inside the second waterproof tube 4 by using the air pressure, so as to quickly restore the normal use of the connector 2. This design greatly simplifies the maintenance process, and improves the user's operating convenience.

In an embodiment, the connecting head 22 is provided with a third connecting post, and the mounting seat 21 is provided with a fourth connecting post. Both ends of the flexible tube 23 are socketed to the third connecting post and the fourth connecting post respectively.

By adopting the structure of socketed connection, the sealing and solidity of the connection between the flexible tube 23 and the mounting seat 21 and the connecting head 22 at both ends of the flexible tube 23 is further enhanced.

In an embodiment, the second waterproof tube 4 utilizes the principle of surface tension of water to form a water column inside the second waterproof tube 4 when water is entering to

prevent further intrusion of external water into the pressure sensor 3 through the second waterproof tube 4.

Specifically, to realize the waterproof function of the second waterproof tube 4 by utilizing the principle of surface tension of liquid, it is only necessary to set the inner diameter of the second waterproof tube 4 small enough to form a water column when water enters. The second waterproof tube 4 of this structure has the advantages of simple structure and low cost.

In an embodiment, the inner diameter of the second waterproof tube 4 ranges from 1.5 mm to 3.5 mm.

The inner pipe diameter of the second waterproof tube 4 is set to range from 1.5 mm to 3.5 mm, so that normal air permeability requirements are satisfied while realizing the function of forming a water column inside the second waterproof tube 4 by using the liquid surface tension to realize waterproofing.

Further preferably, the inner diameter of the second waterproof tube 4 ranges from 2.5 mm to 2.7mm, which is a small size range that is sufficient for stable air permeability and can ensure stable formation of a water column when water enters.

In an embodiment, the inner tube diameter of the air guide tube 5 ranges from 5 mm to 12 mm.

The inner pipe diameter of the air guide tube 5 is set to range from 5 mm to 12 mm, which can guarantee enough response speed of the air pressure, so that the pressure sensor 3 can sense the air pressure change in a timelier manner, thereby improving the accuracy and real-time nature of the measurement.

In an embodiment, referring to FIGS. 4 to 5, the pressure sensor 3 includes a sensor body 31. The sensor body 31 is provided with a sensor insertion tube 32 on one side. The second sensitive element is provided in the sensor insertion tube 32. The connector 2 is provided with a sensing connection hole connected to the second sensing air chamber 211, and the sensor insertion tube 32 is inserted into the sensing connection hole, enabling the second sensitive element to sense the internal air pressure of the second sensing air chamber 211.

The sensing connection hole specially designed on the connector 2 is a bridge connecting the second sensing air chamber 211 and the sensor insertion tube 32, and the sensor insertion tube 32 is connected to the sensing connection hole through plug-in connection, which is not only simple and quick, but also ensures the sealing and reliability of the connection. After the plug-in connection, the second sensitive element is able to be directed towards the inside of the second sensing air chamber 211 and sense changes in air pressure inside the second sensing air chamber 211.

In an embodiment, a sealing ring 33 is provided in the sensing connection hole, and the sensor insertion tube 32 is inserted into the sealing ring 33.

The sealing ring 33 is placed in the sensing connection hole, so that when the sensor insertion tube 32 is inserted into the sealing ring 33, the sealing ring 33 will be tightly compressed between the sensor insertion tube 32 and the sensing connection hole to form an effective sealing barrier This sealing effect effectively ensures the airtightness within the second sensing air chamber 211, so that the air pressure within the second sensing air chamber 211 accurately responds to the liquid pressure, thereby ensuring the accuracy of the liquid level detection.

In an embodiment, the pressure sensor 3 further includes a first sensitive element for sensing the atmospheric pressure.

That is, this pressure sensor 3 is a differential sensor, which can also realize the purpose of accurately detecting the liquid level height when the atmospheric pressure changes.

In an embodiment, the barometric level gauge includes a housing top cover 12, and the housing top cover 12 is mounted onto the connector 2 and covers the pressure sensor 3.

Specifically, the main function of the housing top cover12 is to protect the pressure sensor 3 from impact of the external environment. The housing top cover12 is mounted onto the connector 2 to form a space that isolates the pressure sensor 3 from possible dust, moisture, corrosive gases and the like, thereby prolonging the service life of the pressure sensor 3 and improving the measurement accuracy thereof.

In addition, the sealed space between the housing top cover 12 and the connector 2 can also be used for installing components such as a main control circuit board 7 required in the barometric level gauge, which also functions as isolation protection.

On the other hand, embodiments of the present disclosure provides a liquid storage device, including a liquid storage tank and a barometric level gauge as described above. The connector 2 of the barometric level gauge is mounted on the top of the liquid storage tank, and an end, away from the connector 2, of the air guide tube 5 of the barometric level gauge extends to the bottom of the inside of the liquid storage tank.

Similarly, the barometric level gauge in the liquid storage device of the present embodiment has the advantage of good waterproof capability.

On another hand, embodiments of the present disclosure provides a plant protection equipment, including a carrier, a spraying system, and the aforementioned liquid storage device. The spraying system and the liquid storage device are mounted on the carrier, and the spraying system is configured to pump and atomize medicinal liquid in the liquid storage device for spraying.

Therein, the carrier may be an unmanned vehicle, an unmanned aircraft, an artificially driven vehicle and the like.

The spraying system includes a pumping device and an atomizer, etc. Pipelines at both ends of the pumping device are connected to the storage tank and the atomizer respectively, and the medicinal liquid in the storage tank is pumped out by the pumping device and then uniformly sprayed on the crop after atomization by the atomizer. Based on the transportation of the carrier, mobile spraying operation can be realized.

Based on the liquid storage device of the present embodiment, similarly, the barometric level gauge in the plant protection equipment of the present embodiment has the advantages of strong waterproof capability and long service life.

The pressure sensor 3 disposed in the barometric level gauge, which is located on the top of the medicinal liquid tank, is generally a differential pressure sensor to ensure enough detection accuracy. The differential pressure sensor has at least two pressure detection points, one of which is used to detect barometric pressure in the vent tube, and the other detection point is used to detect atmospheric pressure. By obtaining a difference between the internal and external pressures and converting it into a liquid level height, impact of atmospheric pressure changes on liquid level detection accuracy can be avoided. Due to the need for the pressure sensor 3 to be connected to the atmosphere in order to detect the atmospheric pressure, the pressure sensor 3 cannot be installed in an absolutely sealed environment. Therefore, it is usually necessary to set up vents on a housing 1 of the barometric level gauge to maintain atmospheric connection. However, in the field of agricultural plant protection, the working environment of equipment is usually outdoor, and rainwater, river water, and cleaning water that are usually in contact with it can easily invade the inside of the barometric level gauge through the vents, leading to damage, caused by water, to the pressure sensor 3 and circuit board disposed inside the barometric level gauge in related technologies.

In order to overcome the above technical problems, with reference to FIGS. 1, 4 and 5, the present embodiment also provides another barometric level gauge, which is capable of effectively preventing splashing water from outside, such as rainwater, cleaning water, etc., from entering into the interior of the barometric level gauge, which may cause damage, caused by water, to the internal electronic devices. It should be noted that the barometric level gauge of this embodiment can be used in combination with the design points of any one or more of the barometric level gauges of the above embodiments.

The barometric level gauge of this embodiment includes a housing 1, a pressure sensor 3, and a first waterproof tube 6. The housing 1 is provided with a device mounting cavity 16. The

device mounting cavity 16 is provided with a separate first sensing air chamber 161. The housing 1 is provided with a first vent 18 connected to the first sensing air chamber 161, and the pressure sensor 3 is mounted in the device mounting cavity 16 to sense the internal air pressure of the first sensing air chamber 161. The first waterproof tube 6 is connected to the first vent 18 at one end and connected to the atmospheric pressure at the other end, so that the first sensing air chamber 161 communicates with the atmosphere through the first waterproof tube 6.

Therein, the device mounting cavity 16 is used for mounting devices such as the pressure sensor 3, the main control circuit board 7, etc., which can be adequately protected by utilizing the housing 1. The first sensing air chamber 161 is a portion separated from the device mounting cavity 16 and its volume is necessarily smaller than the volume of the entire device mounting cavity 16. The pressure sensor 3 is provided with a first sensitive element for sensing the air pressure within the first sensing air chamber 161, and the pressure sensor 3 may be mounted in the first sensing air chamber 161 or outside of the first sensing air chamber 161 when the pressure sensor 3 is mounted, as long as the first sensitive element on the pressure sensor 3 can be aligned with and directed toward the first sensing air chamber 161.

Therein, under normal conditions, the first waterproof tube 6 can connect the first sensing air chamber 161 to the outside environment, realizing the connection between the first sensing air chamber 161 and the atmosphere. When exposed to water, effective waterproofing can be realized through the first waterproof tube 6, and the waterproof principle of the first waterproof tube 6 is similar to that of a capillary tube, so that when external liquid enters the first waterproof tube 6 through an end, away from the first sensing air chamber 161, of the first waterproof tube 6, the liquid is prone to form a water column under liquid tension in the first waterproof tube 6, and the water column can separate a space between the device mounting cavity 16 and the first waterproof tube 6 from the outside environment, acting as a seal to stop air between the pressure sensor 3 and the first waterproof tube 6 to be discharged. When the pressure of the external liquid is balanced with the pressure of the air inside the first waterproof tube 6, the liquid cannot continue to enter, thus achieving the purpose of waterproofing for the pressure sensor 3.

In view of above, based on the barometric level gauge of this embodiment, an independent first sensing air chamber 161 is provided in the device installation cavity 16 of the barometric level gauge, and the pressure sensor 3 is provided to sense the air pressure in the first sensing air chamber 161. A first waterproof tube 6 is provided on the housing 1 of the barometric level gauge to be connected to the internal first sensing air chamber 161, and the first sensing air chamber 161 is in communication with the atmosphere through the first waterproof tube 6 to realize the function of the pressure sensor 3 to sense the atmospheric pressure. Therein, the first waterproof tube 6 has a

small circulation area, similar to a capillary tube. When an external liquid enters the first waterproof tube 6, the liquid is prone to form a water column inside the first waterproof tube 6 under liquid tension, and the water column can isolate the first sensing air chamber 161 from the outside environment, acting as a seal to stop air in the first sensing air chamber 161 to be discharged. When the pressure of the external liquid is balanced with the pressure of the air inside the first sensing air chamber 161, the liquid cannot continue to enter, thus achieving the purpose of waterproofing for the first sensing air chamber 161. Therefore, under normal use, the pressure sensor 3 of the barometric level gauge of the present solution can be connected to the atmospheric to detect the atmospheric pressure in real time, and can also be effectively isolated from the outside environment when exposed to water, so as to realize the purpose of effectively waterproofing and providing effective protection for the pressure sensor 3 sensor used for the pressure sensing inside the first sensing air chamber 161. Furthermore, since the first sensing air chamber 161 is provided for communicating with the atmospheric pressure, the device mounting cavity 16 does not need to be provided with air permeability, and it can be completely sealed, so the problem of water ingress into the main control circuit board 7 and other circuit devices in the device mounting cavity 16 can be completely avoided.

After the inventors have deeply researched and developed, when there is a soaking accident, the external water enters into the first waterproof tube 6 through the second vent 19 and a water column may be formed inside the first waterproof tube 6. The deeper the soaking water is, the greater the external water pressure is, and the greater the counteracting air pressure needs to be provided inside the device mounting cavity 16, thus requiring a greater degree of compression of the water column thereof. It should be understood that as the volume of the device mounting cavity 16 increases, the more gas needs to be compressed when the same pressure needs to be increased, i.e., the longer the length of the water column needs to be. Generally, devices such as control circuit boards are also to be installed in the device mounting cavity 16, which results in the space of the device mounting cavity 16 not being able to be made smaller. Therefore, in order to realize an improved waterproofing capability against deep water, extending the first waterproofing tube 6 is one of the ways. However, there is a limited amount of space on the housing 1 for the first waterproofing tube 6, and it is generally difficult to provide a first waterproofing tube 6 of a very long length in order to provide sufficient waterproofing capability.

In order to overcome the above problem, the first sensing air chamber 161 of the resent embodiment is separated from the device mounting cavity 16, so its volume is obviously smaller than the entire device mounting cavity 16. Thus, when water enters, the water column in the first waterproof tube 6 can simply compress the air in the first sensing air chamber 161, which makes

it easier to compress the gas in the first sensing air chamber 161 of a much smaller volume to have sufficient pressure relative to compressing the gas in the entire device mounting cavity 16. Therefore, based on this improvement, a better capability of waterproof against deep water can also be obtained in the case where a short first waterproof tube 6 is provided.

Based on the design of the first waterproof tube 6, the barometric level gauge of the present embodiment is made to provide soaking waterproof capability in addition to the waterproof function against conventional splashing water. In other words, even if the barometric level gauge is completely soaked in water, the first waterproof tube 6 can be utilized to prevent water from entering into the first sensing air chamber 161. The advantage of this barometric level gauge is particularly obvious in the application of automatic spraying equipment carried by the drone. Since the barometric level gauge of the present solution can realize effective waterproof function even if the entire barometric level gauge is soaked in water. In a case where the automatic spraying equipment is carried by the drone to carry out the work of plant protection, it is also possible to avoid water ingress into the interior of the barometric level gauge even if both the drone and pesticide tank become submerged when the drone meets accidental water ditching during overwater flight.

In addition, when the first waterproof tube 6 of the barometric level gauge is clogged with water, water in the first waterproof tube 6 can be expelled by shaking or tapping, etc., restore normal functionality of the barometric level gauge.

In the initial waterproof design of the pressure sensor 3, the most immediate thought of the inventor is to set up a waterproof breathable valve at a vent of the housing. The waterproof breathable valve provides gas-permeable yet water-impervious functionality, precisely meeting the dual performance requirements of ventilation and waterproofing. However, in practical application, the inventor found that when a permeable membrane inside the waterproof breathable valve sticks to water, it is necessary to disassemble the entire waterproof breathable valve, dry the permeable membrane and then reassemble it. The drainage process is complicated. More importantly, since the permeable membrane inside the waterproof breathable valve cannot be seen outside the waterproof breathable valve directly, the user is often unable to determine whether or not the permeable membrane sticks to water, and it is often necessary to disassemble the waterproof breathable valve and then check the permeable membrane, thus causing a certain burden on users' usage. After many experiments and research, the inventor creatively designed the breathable waterproof structure with the first waterproof tube 6 provided in embodiments of the present disclosure. A transparent tube may be adopted as the first waterproof tube 6, so that the user can intuitively observe whether the first waterproof tube 6 is waterlogged or not before usage. When

the first waterproof tube 6 is found to be waterlogged, the water can be expelled by shaking or slight tapping the first waterproof tube 6. Compared to using a waterproof breathable valve for waterproofing, the first waterproof tube 6 of the present solution is more user-friendly

In an embodiment, the pressure sensor 3 is installed in the first sensing air chamber 161, which includes a first sensitive element for sensing the internal air pressure of the first sensing air chamber 161.

By installing the pressure sensor 3 within the first sensing air chamber 161, it is easier to seal and isolate of the first sensing air chamber 161. Moreover, as the pressure sensor 3 can occupy a large portion of the space within the first sensing air chamber 161 for the purpose of greatly reducing the air volume of the first sensing air chamber 161, it is more conducive to improving the deep-water resistance of the present embodiment.

In an embodiment, referring to FIGS. 3 to 4, a main control circuit board 7 is provided in the device mounting cavity 16. The housing 1 is provided with an air chamber groove located on one side of the device mounting cavity 16, and the main control circuit board 7 is secured to the housing 1 and covers the air chamber groove to separate the first sensing air chamber 161.

The main control circuit board 7, as one of the core components of the barometric level gauge, is not only responsible for controlling the operation and data processing of the whole device, but also plays a role of separating the space in this design. The main control circuit board 7 is mounted inside the device mounting cavity 16 and its position is skillfully arranged to cover the air chamber groove, so that the main control circuit board 7 naturally serves as a separator, separating the device mounting cavity 16 into two parts: one part is the main control circuit board 7 and its peripheral area for mounting other necessary electronic components; and the other part is the covered air chamber groove, i.e., the first sensing air chamber 161. Based on this, it is realized that the independent first sensing air chamber 161 is separated without adding additional parts and complex structures by using original devices of the barometric level gauge, and the purpose of improving the deep-water waterproof resistance is achieved. Thus, the present solution has the advantages of simple structure and low cost.

In an embodiment, referring to FIGS. 3 to 4, the housing 1 includes a housing base 11 and a housing top cover 12. The housing top cover 12 is mounted onto the housing base 11 to form the device mounting cavity 16 between the housing base 11 and the housing top cover 12. The air chamber groove is provided in the housing base 11, and the main control circuit board 7 is fixed on the housing base 11.

The housing 1 consists of two parts, the housing base 11 and the housing top cover 12. The housing base 11 is a supporting and fixing structure on which various electronic components and parts can be mounted, and the housing top cover 12 is mounted onto the housing base 11, and is tightly combined with the housing base 11 through sealing connections (such as screws, snaps or glue, etc.) so as to form a relatively closed space between the two, i.e., the device mounting cavity 16. The air chamber groove is provided on the housing base 11, realizing the mounting of the pressure sensor 3 to the housing base 11, enabling it to be directly aligned with the connector 2 on the housing base 11, and realizing the function of the pressure sensor 3 to detect the atmospheric pressure as well as the liquid side pressure. The main control circuit board 7 is fixedly mounted on the housing base 11, and the main control circuit board 7 naturally serves to separate the first sensing air chamber 161 from the device mounting cavity 16.

In an embodiment, a hermetic ring 113 around the air chamber groove is provided between the main control circuit 30 board 7 and the housing base 11.

By introducing the hermetic ring 113, the contact surface between the main control circuit board 7 and the housing base 11 is better sealed, thereby improving the hermeticity of the first sensing air chamber 161.

In an embodiment, one side, for contacting the main control circuit board 7, of the hermetic ring 113 is provided with a convex rib strip 1131 around the air chamber groove, and at least two convex rib strips 1131 are set at intervals.

The design of the convex rib strips 1131 forms a plurality of sealing lines which can more effectively block the penetration of moisture and gases for ensuring the airtightness of the first sensing air chamber 161.

In an embodiment, the housing base 11 is provided with a support tab 111 disposed around the air chamber groove. The support tab 111 is provided with a hermetic groove 112, and the hermetic ring 113 is embedded in the hermetic groove 112 for installation.

The combined design of the support tab 111 and the hermetic groove 112 enables the hermetic ring 113 to be partially embedded in the hermetic groove 112 and supported and secured by the support tab 111, thereby improving the reliability of the installation of the hermetic ring 113. In addition, the sealing effect of the hermetic ring 113 may be more significant.

In an embodiment, the housing base 11 is provided with a plurality of mounting threaded holes provided around the air chamber groove, and the main control circuit board 7 is provided with positioning holes corresponding to the mounting threaded holes. Mounting screws pass through the positioning holes and are thread-locked attached to the mounting threaded holes, so as to enable the main control circuit board 7 to be tightly pressed against the hermetic ring 113.

During installation, the mounting screws are used to pass through the positioning holes on the main control circuit board 7 and are threaded into the mounting threaded holes on the housing base 11. As the screws are tightened, the main control circuit board 7 is gradually pressed against the housing base 11. Meanwhile, the hermetic ring 113 is also tightly pressed between the two, and the compression ensures that a reliable sealing interface is formed between the hermetic ring 113 and the main control circuit board 7, and between the hermetic ring 113 and the housing base 11, thereby effectively preventing moisture from penetrating into the hermetic ring 113. Meanwhile, this structure has the advantage of being repeatedly disassembled for maintenance.

Preferably, a plurality of circuit board locking attachments are provided on the housing base 11, and the circuit board locking attachments are provided with the mounting threaded holes, so that the main control circuit board 7 is mounted on the circuit board locking attachments, and then mounted with screws for fixing, which can reliably mount the main control circuit board 7 and enable the main control circuit board 7 to be in close contact with the hermetic ring 113.

In an embodiment, a protruded connector 2 for connecting the air guide tube 5 is provided on a side, back to the housing top cover 12, of the housing base 11, and the first vent 18 is located in the housing base 11 avoiding the connector 2. The air chamber groove includes a sensor mounting area 1611 and a narrow by-pass airway 1612. The sensor mounting area 1611 is provided corresponding to the connector 2, and the narrow by-pass airway 1612 is connected to the sensor mounting area 1611 and the first vent 18.

Specifically, a differential pressure sensor is adopted as the pressure sensor 3, and the differential pressure sensor 3 includes at least a first sensitive element and a second sensitive element. The first sensitive element is configured to sense the atmospheric pressure and the second sensitive element is configured to sense the pressure of an air chamber connected to liquid. In order to realize that the first sensitive element and the second sensitive element can each perform its own function, in this embodiment, a connector 2 is provided on a side of the housing base 11, and the connector 2 is connected to an air guide tube 5 extending into the liquid. A second sensing air chamber 211 is provided in the connector 2 in connection with the air guide tube 5. After the pressure sensor 3 is fixedly mounted inside the device mounting cavity 16, the first sensitive element is located exactly on the device mounting cavity 16 side, and the second sensitive element is located exactly facing the second sensing air chamber 211. After the pressure sensor 3 is installed, the second sensing air chamber 211 and the device mounting cavity 16 are precisely isolated, so that as long as the device mounting cavity 16 is in communication with the atmosphere, the first sensitive element can sense the atmospheric pressure, and the second sensitive element can sense the air pressure on the liquid side. Preferably, referring to FIG. 5, in order to make the second sensing air chamber 211 and the device mounting cavity 16 be effectively isolated, the pressure sensor 3 includes a sensor body 31 and a sensor insertion tube 32. The first sensitive element is located on a side of the sensor body 31, and the second sensitive element is aligned with a tube lumen of the sensor insertion tube 32. At a connection position between the device mounting cavity 16 and the second sensing air chamber 211, a sealing ring 33 is provided. In the device mounting cavity 16, the sensor insertion tube 32 is inserted into the sealing ring 33, so that the second sensing air chamber 211 can be effectively isolated from the device mounting cavity 16 based on the installation of the pressure sensor 3 and the sealing ring 33.

The air chamber groove is set into two parts, the sensor mounting area 1611 and the narrow by-pass airway 1612. The pressure sensor 3 is installed in the sensor mounting area 1611, so that the sensor insertion tube 32 can be directly aligned with the second sensing air chamber 211 in the connector 2, so as to facilitate the installation of the pressure sensor 3.In addition, the narrow by-pass airway 1612 is used to connect the first vent 18 with the sensor mounting area 1611, so as to enable sensor mounting area 1611 to communicate with the second waterproof tube 6, thereby realizing the function of sensing atmospheric pressure by the pressure sensor 3. This structure can maximally reduce the volume of the entire first sensing air chamber 161 on the basis of satisfying the need for air permeability, thereby realizing the purpose of improving the waterproofing ability against deep water.

In another embodiment, a protruded connector 2 for connecting the air guide tube 5 is provided on a side, back to the housing top cover 12, of the housing base 11, and the air chamber groove is provided corresponding to the connector 2. The first vent 18 is located on a side of the connector 2 and connected to the air chamber groove.

In this embodiment, the first vent 18 is directly provided on the side of the connector, enabling the first vent 18 to be directly connected to the air chamber groove inside the connector 2 to obtain the shortest connection path, thereby minimizing the volume of the air chamber groove.

In an embodiment, the housing base 11 is provided with a vent chamber 17 on a side, back to housing top cover 12, of the housing base 11, and the first waterproof tube 6 is coiled around the connector 2 in the vent chamber 17.

As the vent chamber 17 is provided on the side, back to the housing top cover 12, of the housing base 11, the vent chamber 17 may be utilized to accommodate the first waterproof tube 6 to provide concealment and protection for the first waterproof tube 6. In addition, when a soaking accident occurs, external water enters the first waterproof tube 6 and a water column is formed inside the first waterproof tube 6. The deeper the water is, the greater the external water pressure will be. With a greater pressure exerted by the water column to the device mounting cavity 16, the water column will be the longer, and gas in the device mounting cavity 16 will be compressed by the water column to a great degree, so that the air pressure in the device mounting cavity 16 increases to a larger extent. When a balance is achieved between the air pressure in the device mounting cavity 16 and the external water pressure, the water column cannot continue to extend inward. Therefore, a length of the water column that can be formed inside the first waterproof tube 6 determines the waterproofing ability of the device mounting cavity 16. The longer the length of the water column that can be formed, the device mounting cavity 16 can maintain effective waterproofing in the deeper the water, i.e., to obtain a better waterproofing capability and resistance to deep water. In this embodiment, the first waterproof tube 6 is set to form into a coiled shape around the connector 2, which can effectively utilize a limited space in the vent chamber 17 to fully arrange the first waterproof tube 6. Importantly, the coiled first waterproof tube 6 also has the advantage of a long length while occupying less space, which can obtain a better waterproofing capability and resistance to deep water.

In an embodiment, referring to FIGS. 8 to 9, a tube clip 114 is provided on a side, back to the housing top cover 12, of the housing base 11. The first waterproof tube 6 is fastened to the tube clip 114.

The design of the tube clip 114 enables the first waterproof tube 6 to be firmly fixed to the inner partition plate 15, avoiding loosening or falling off due to external factors such as vibration, impact, etc., and this solid connection ensures the reliability of the first waterproof tube 6 in the process of long-term use, and prevents a problem of leakage of water or air due to unstable connection.

In an embodiment, the housing base 11 is provided with a second vent 19 at a side portion of the housing base 11. The vent chamber 17 communicates with the atmosphere through the second vent 19.

Specifically, the second vent 19 provided on the side of the housing base 11 is configured to communicate with the atmosphere. It can be understood that, after the application of the barometric level gauge provided in the present embodiment is installed, the device mounting cavity 16 is located above the vent chamber 17, i.e., the first vent 18 is also located above the vent chamber 17. When there is a scenario such as a rain shower or a cleaning, etc., even if splashed water enters into the vent chamber 17 through the side wall 13, or through the hole or the slot, etc., in the medicinal liquid tank that are connected with the vent chamber 17, it is difficult to splash upwards again inside the vent chamber 17 and enter the device mounting cavity 16 through the first vent 18.

Thus, the design structure of the housing itself can be utilized to prevent most of the splashing water from entering to achieve the purpose of waterproofing. In most cases, the water will not enter the first waterproof tube 6, thus reducing the number of times the user has to drain the first waterproof tube 6. The main function of the first waterproof tube 6 of the present embodiment is to provide fail-safe waterproof protection. Splashing water from the outside cannot enter the first waterproof tube 6 during regular use. During an immersion condition, based on the setting of the first waterproof tube 6, external water can be prevented from entering the device mounting cavity 16 through the first waterproof tube 6, thereby maintaining designed waterproof functionality even in the immersion condition. The advantage of the barometric level gauge with the first waterproof tube 6 is particularly obvious in application of an automatic spraying equipment carried by a drone. Since the barometric level gauge of the present solution can realize effective waterproof function even if the entire barometric level gauge is soaked in water. In a case where the automatic spraying equipment is carried by the drone to carry out the work of plant protection, it is also possible to avoid water ingress into the interior of the barometric level gauge even if both the drone and pesticide tank become submerged when the drone meets accidental water ditching during overwater flight.

In an embodiment, the first waterproof tube 6 utilizes the principle of surface tension of water to form a water column in the first waterproof tube 6 when water is entering to prevent further intrusion of external water into the pressure sensor 3 through the first waterproof tube 6.

Specifically, to realize the waterproof function of the first waterproof tube 6 by utilizing the principle of surface tension of liquid, it is only necessary to set the inner diameter of the first waterproof tube 6 small enough to form a water column therein when water enters, and the first waterproof tube 6 of this structure has the advantages of simple structure and low cost.

In an embodiment, the inner diameter of the first waterproof tube 6 ranges from 1.5 mm to 3.5 mm.

By setting the inner diameter of the first waterproof tube 6 to range from 1.5 mm to 3.5 mm, normal air permeability requirements may be satisfied while realizing the function of waterproofing by using liquid surface tension to form a water column inside the first waterproof tube 6.

On the other hand, embodiments of the present disclosure provides a liquid storage device, including a liquid storage tank and a barometric level gauge as described above. The housing 1 of the barometric level gauge is mounted on the top of the liquid storage tank, and an end, away from the housing 1, of an air guide tube 5 of the barometric level gauge extends inside the liquid storage tank.

Similarly, the barometric level gauge in the liquid storage device of the present embodiment has the advantage of good waterproof capability.

On another hand, embodiments of the present disclosure provides a plant protection equipment, including a carrier, a spraying system, and the aforementioned liquid storage device. The spraying system and the liquid storage device are mounted on the carrier, and the spraying system is configured to pump and atomize medicinal liquid in the liquid storage device for spraying.

Therein, the carrier may be an unmanned vehicle, an unmanned aircraft, an artificially driven vehicle and the like.

The spraying system includes a pumping device and an atomizer, etc. Pipelines at both ends of the pumping device are connected to the storage tank and the atomizer respectively, and the medicinal liquid in the storage tank is pumped out by the pumping device and then uniformly sprayed on the crop after atomization by the atomizer. Based on the transportation of the carrier, mobile spraying operation can be realized.

Based on the liquid storage device of the present embodiment, similarly, the barometric level gauge in the plant protection equipment of the present embodiment has the advantages of strong waterproof capability and long service life.

In the description herein, it is to be understood that the terms "up", "down", "left", "right", etc., are only used in the context of an orientation or positional relationship. The terms "up", "down", "left", "right", etc. are used in relation to orientation or position only for the purpose of facilitating description and simplifying operation, and are not intended to indicate or imply that the device or element referred to must have a particular orientation, be constructed and operated in a particular orientation, and therefore are not to be construed as a limitation of the present disclosure. In addition, the terms "first" and "second" are used only to make a distinction in the description and have no special meaning.

In the description of the present specification, the description with reference to the terms "an embodiment", "example", etc. is intended to mean that the specific features, structures, materials, or characteristics described in connection with the embodiment or example are included in at least one embodiment or example of the present disclosure. In this specification, schematic representations of the above terms do not necessarily refer to the same embodiment or example.

In addition, it should be understood that although the present specification is described in accordance with the embodiments, not each embodiment contains only one independent technical solution, and the specification is recited in such a manner merely for the sake of clarity, and a person skilled in the art should take the specification as a whole, and the technical solutions in each embodiment may also be appropriately combined to form other embodiments that can be understood by a person skilled in the art.

The technical principles of the present disclosure are described above in connection with specific embodiments. These descriptions are only intended to explain the principles of the present disclosure and are not to be construed in any way as a limitation of the scope of protection of the present disclosure. Based on the explanations herein, those skilled in the art can associate other specific embodiments of the present disclosure, which will fall within the scope of protection of the present disclosure, without the need for creative effort.

What is claimed is:

1. A barometric level gauge, comprising:
a housing, comprising a side wall, and a top cover plate and an inner partition plate respectively connected to the side wall, wherein a device mounting cavity is formed between the top cover plate and the inner partition plate and a vent chamber is formed on a side, back to the top cover plate, of the inner partition plate, the vent chamber is in communication with atmosphere, and the inner partition plate is provided with a first vent connecting the device mounting cavity to the vent chamber, enabling the device mounting cavity to communicate with the atmosphere; and
a pressure sensor, mounted in the device mounting cavity, wherein the pressure sensor comprises a first sensitive element for sensing air pressure in the device mounting cavity.

2. The barometric level gauge according to claim 1, wherein the vent chamber is provided with a first waterproof tube, and one end of the first waterproof tube is connected to the first vent and the other end is a free end, enabling the device mounting cavity to communicate with the vent chamber through the first waterproof tube.

3. The barometric level gauge according to claim 2, wherein the first waterproof tube comprises a main body of the first waterproof tube and a vent connector connected with each other, and the vent connector is connected to the first vent through plug-in connection.

4. The barometric level gauge according to claim 3, wherein a flexible tube is connected between the main body of the first waterproof tube and the vent connector, and an inner diameter of the flexible tube is greater than an inner diameter of the main body of the first waterproof tube.

5. The barometric level gauge according to claim 2, wherein the inner partition plate is provided with a tube clip on the side, back to the top cover plate, of the top cover plate, and the first waterproof tube is fastened to the tube clip.

6. The barometric level gauge according to claim 5, wherein the inner partition plate is provided with a connector protruding backwardly to the top cover plate, the connector is configured to be connected to an air guide tube, and the first waterproof tube is coiled around the connector.

7. The barometric level gauge according to claim 6, wherein the tube clip comprises an arcuate tube clipping plate, the arcuate tube clipping plate is provided on a side, back to the first vent, of the connector, and a first tube clip groove is provided between the arcuate tube clipping plate and the connector to clamp the first waterproof tube.

8. The barometric level gauge according to claim 7, wherein the tube clip further comprises a block, and the block is provided with a second tube clip groove to clamp the first waterproof tube.

9. The barometric level gauge according to claim 2, wherein the first waterproof tube is configured to prevent further intrusion of external water into the pressure sensor through the first waterproof tube by utilizing a principle of surface tension of water to form a water column in the first waterproof tube when water is fed.

10. The barometric level gauge according to claim 1, wherein the side wall is provided with a second vent connected to the vent chamber, enabling the vent chamber to communicate with the atmosphere.

11. The barometric level gauge according to claim 10, wherein the housing comprises a housing base and a housing top cover, the housing base comprises a first enclosure plate and the inner partition plate connected to each other; the housing top cover comprises a second enclosure plate and the top cover plate connected to each other, the housing top cover is mounted onto the housing base, the first enclosure plate is connected with the second enclosure plate to form the side wall, and the second vent is provided in the first enclosure plate.

12. The barometric level gauge according to claim 11, wherein the inner partition plate is provided protruding, relative to the first enclosure plate, towards the top cover plate, an inner cavity of the second enclosure plate corresponds to an external dimension of the inner partition plate and the inner partition plate is embedded in the second enclosure plate.

13. The barometric level gauge according to claim 12, wherein the second enclosure plate comprises a first enclosure portion and a second enclosure portion connected in a stepped structure, a step portion in parallel with the inner partition plate is formed between the first enclosure portion and the second enclosure portion, a waterproof ring is provided in the first enclosure portion to abut against the step portion, and the inner partition plate is embedded within the first enclosure portion and pressed against the waterproof ring.

14. The barometric level gauge according to claim 13, wherein the step portion is provided with an annular groove and the waterproof ring is embedded in the annular groove.

15. The barometric level gauge according to claim 14, wherein the inner partition plate is provided with an annular flange at a peripheral of the inner partition plate, and the annular flange is embedded in the annular groove to be pressed against the waterproof ring.

16. The barometric level gauge according to claim 1, wherein the side wall and the top cover plate are of an integrated structure, and the inner partition plate is embedded within the side wall.

17. The barometric level gauge according to claim 1, wherein the side wall is provided with a mounting tab on a side away from the top cover plate, and the mounting tab is provided with a mounting hole.

18. The barometric level gauge according to claim 1, wherein the barometric level gauge is applied in a medicinal liquid tank for plant protection.

19. A liquid storage device, comprising a liquid storage tank and the barometric level gauge according to claim 1.

20. A plant protection equipment, comprising: a carrier, a spraying system, and the liquid storage device according to claim 19, wherein the spraying system and the liquid storage device are mounted on the carrier, and the spraying system is configured to pump and atomize medicinal liquid in the liquid storage device for spraying.
